(19) United States
(12) Patent Application Publication
(10) Pub. No.: US 2021/0110129 A1
(43) Pub. Date: Apr. 15, 2021

(54) THIN FILM TRANSISTOR (TFT) FINGERPRINT SENSOR

(71) Applicant: QUALCOMM Incorporated, San Diego, CA (US)

(72) Inventors: Subbarao CHAKKIRALA, San Jose, CA (US); Sameer WADHWA, San Diego, CA (US)

(21) Appl. No.: 16/600,264

(22) Filed: Oct. 11, 2019

(51) Int. Cl. G06K 9/00; G09G 3/36

(52) U.S. Cl. CPC G06K 9/0002; G09G 2330/00; G09G 2300/0842; G09G 3/3696

(57) ABSTRACT

Disclosed are techniques for sensing an ultrasonic signal. In aspects, a pixel circuit includes a first switch coupled to a first input signal configured to drive the first switch, a second switch coupled to a second input signal configured to drive the second switch, a capacitor coupled to the first switch and the second switch and configured to detect the ultrasonic signal, an output device coupled to the second switch and a power supply for the pixel circuit, wherein the output device is configured to store an input signal from the capacitor, wherein the input signal from the capacitor is received at the output device from the second switch, and an output switch coupled to the output device and a column of a pixel array, wherein the output device is configured to output the input signal to the column of the pixel array based on activation of the output switch.

### 1. FIELD OF USE

Various aspects described herein generally relate to thin film transistor (TFT) fingerprint sensors.

### 2. BACKGROUND

A number of technologies have been developed to capture a digital image of a user's fingerprint pattern, including optical scanners, capacitive or complementary metal-oxide-semiconductor (CMOS) scanners, ultrasonic scanners, thermal scanners, etc. Optical scanners capture a visual image of the fingerprint using a digital camera. Capacitive or CMOS scanners use capacitors, and thereby electrical current, to form an image of the fingerprint. Ultrasonic scanners use high frequency sound waves to penetrate the epidermal (outer) layer of the skin. Thermal scanners sense the temperature differences on the contact surface, for example, in between fingerprint ridges and valleys.

Unlike existing optical or capacitive-based fingerprint scanners, ultrasonic fingerprint scanners make use of very high-frequency ultrasonic sound. To capture the details of a fingerprint, an ultrasonic pulse is transmitted against the finger that is placed over the scanner. Some of this pulse's pressure is absorbed and some of it is bounced back to the sensor, depending upon the ridges, pores, and other details that are unique to each fingerprint. A sensor calculates the intensity of the returning ultrasonic pulse at different points on the scanner. Scanning for longer periods of time allows for additional depth data to be captured, resulting in a highly detailed three-dimensional (3D) reproduction of the scanned fingerprint.

A thin-film transistor (TFT) is a type of metal-oxide-semiconductor field-effect transistor (MOSFET) made by depositing thin films of an active semiconductor layer, a dielectric layer, and metallic contacts over a supporting (but non-conducting) substrate. A common substrate is glass, due to the common application of TFTs in liquid-crystal displays (LCDs). This differs from the conventional MOSFET transistor, where the semiconductor material is typically the substrate, such as a silicon wafer. There are two approaches to TFT-based fingerprint scanners. The first replaces the silicon wafer substrate but is still a stand-alone fingerprint module, and the other integrates the sensor circuitry into the display's TFT backplane for an in-display solution.

### SUMMARY

This summary identifies features of some example aspects, and is not an exclusive or exhaustive description of the disclosed subject matter. Whether features or aspects are included in, or omitted from this summary is not intended as indicative of relative importance of such features. Additional features and aspects are described, and will become apparent to persons skilled in the art upon reading the following detailed description and viewing the drawings that form a part thereof.

In an aspect, a pixel circuit for sensing an ultrasonic signal includes a first switch coupled to a first input signal configured to drive the first switch, a second switch coupled to a second input signal configured to drive the second switch, a capacitor coupled to the first switch and the second switch and configured to detect the ultrasonic signal, an output device coupled to the second switch and a power supply for the pixel circuit, wherein the output device is configured to store an input signal from the capacitor, wherein the input signal from the capacitor is received at the output device from the second switch, and an output switch coupled to the output device and a column of a pixel array, wherein the output device is configured to output the input signal to the column of the pixel array based on activation of the output switch.

In an aspect, a pixel circuit for sensing an ultrasonic signal includes a capacitor coupled to the first switch and the second switch and configured to detect the ultrasonic signal, a sampling device coupled to the capacitor and configured to sample an input signal from the capacitor, an output device coupled to the sampling device and a power supply for the pixel circuit, wherein the output device is configured to store an input signal from the capacitor, wherein the input signal from the capacitor is received at the output device from the sampling device, an output switch coupled to the output device and a column of a pixel array, and a leakage mitigation device coupled to the sampling device, the output device, and the output switch, wherein the output device is configured to output the input signal to the column of the pixel array based on activation of the output switch.

In an aspect, a pixel circuit for sensing an ultrasonic signal includes a first means for switching coupled to a first input signal configured to drive the first means for switching, a second means for switching coupled to a second input signal configured to drive the second means for switching, a means for sensing coupled to the first means for switching and the second means for switching and configured to detect the ultrasonic signal, a means for outputting coupled to the second means for switching and a power supply for the pixel circuit, wherein the means for outputting is configured to store an input signal from the means for sensing, wherein the input signal from the means for sensing is received at the means for outputting from the second means for switching, and an output means for switching coupled to the means for outputting and a column of a pixel array, wherein the means for outputting is configured to output the input signal to the column of the pixel array based on activation of the output means for switching.

In an aspect, a pixel circuit for sensing an ultrasonic signal includes a means for sensing configured to detect the ultrasonic signal, a means for sampling coupled to the means for sensing and configured to sample an input signal from the means for sensing, an means for outputting coupled to the means for sampling and a power supply for the pixel circuit, wherein the means for outputting is configured to store an input signal from the means for sensing, wherein the input signal from the means for sensing is received at the means for outputting from the means for sampling, an output means for switching coupled to the means for outputting and a column of a pixel array, and a means for leakage mitigation coupled to the means for sampling, the means for outputting, and the output means for switching, wherein the means for outputting is configured to output the input signal to the column of the pixel array based on activation of the output means for switching.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of examples of one or more aspects of the disclosed subject matter and are provided solely for illustration of the examples and not limitation thereof:

FIGS. 1A and 1B show a schematic diagram of an exemplary ultrasonic fingerprint sensor system, according to aspects of the disclosure.

FIG. 2 is an exploded view of an exemplary ultrasonic sensor system, including an ultrasonic transmitter and an ultrasonic receiver under a platen, according to aspects of the disclosure.

FIG. 3 illustrates an exemplary 4-by-4 pixel array of pixel circuits for an ultrasonic receiver, according to aspects of the disclosure.

FIG. 4 illustrates a high-level block diagram of an exemplary ultrasonic sensor system, according to aspects of the disclosure.

FIG. 5 is a schematic of an exemplary conventional pixel circuit that employs a common-mode to peak voltage sampling architecture.

FIG. 6 is a schematic diagram of an exemplary pixel circuit that employs a peak-to-peak voltage sampling architecture, according to aspects of the disclosure.

FIG. 7 is a diagram of an exemplary signal flow through the pixel circuit of FIG. 6, according to aspects of the disclosure.

FIGS. 8A and 8B illustrate the change in capacitance in the pixel circuit of FIG. 6 during sampling and reading, according to aspects of the disclosure.

FIG. 9 illustrates the change in capacitance in the pixel circuit of FIG. 6 during a read operation, according to aspects of the disclosure.

FIG. 10 is a schematic diagram of an exemplary pixel circuit, according to aspects of the disclosure.

FIGS. 11 and 12 illustrate exemplary pixel circuit apparatuses for sensing ultrasonic signals, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein describes particular aspects only and should not be construed to limit any aspects disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

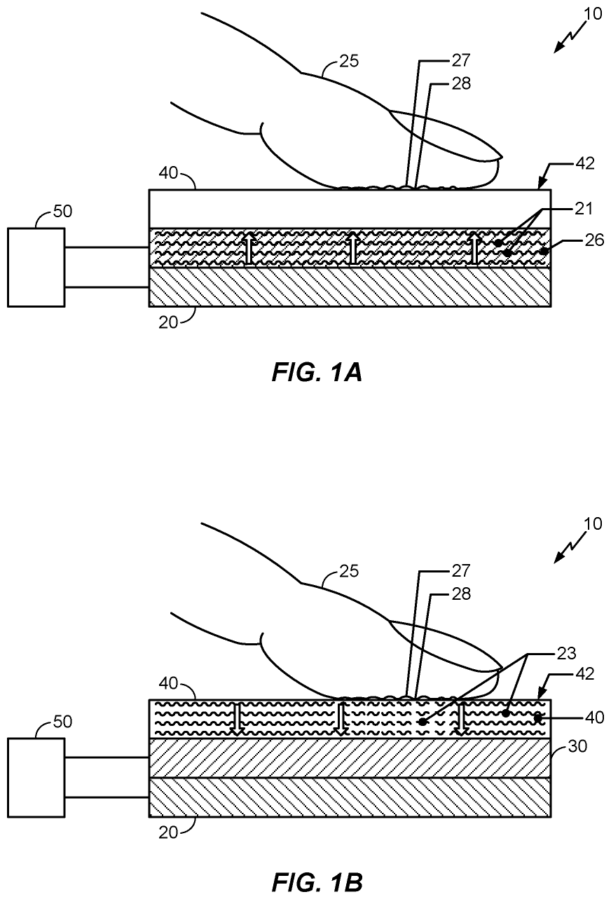

FIGS. 1A and 1B show a schematic diagram of an exemplary ultrasonic fingerprint sensor system 10, according to aspects of the disclosure. As shown in FIG. 1A, ultrasonic fingerprint sensor system 10 includes an ultrasonic transmitter 20 and an ultrasonic receiver 30 under a platen 40 (e.g., the glass surface of an LCD screen). The ultrasonic transmitter 20 may be a piezoelectric transmitter that can generate ultrasonic waves 21. The ultrasonic receiver 30 may be a piezoelectric material and an array of pixel circuits disposed on a substrate. In operation, the ultrasonic transmitter 20 generates ultrasonic waves 21 that travel through the ultrasonic receiver 30 to the exposed surface 42 of the platen 40. At the exposed surface 42 of the platen 40, the ultrasonic energy may either be absorbed or scattered by an object 25 that is in contact with the platen 40, such as the skin of a fingerprint ridge 28, or reflected back. In those locations where air contacts the exposed surface 42 of the platen 40 (e.g., valleys 27 between fingerprint ridges 28), most of the ultrasonic wave 21 will be reflected back toward the ultrasonic receiver 30 for detection.

Control electronics 50 may be coupled to the ultrasonic transmitter 20 and ultrasonic receiver 30 and may supply timing signals that cause the ultrasonic transmitter 20 to generate the ultrasonic waves 21. The control electronics 50 may then receive signals from the ultrasonic receiver 30 that are indicative of the reflected ultrasonic energy 23. The control electronics 50 may use output signals received from the ultrasonic receiver 30 to construct a digital image of the object 25. In some implementations, the control electronics 50 may also, over time, successively sample the output signals to detect movement of the object 25.

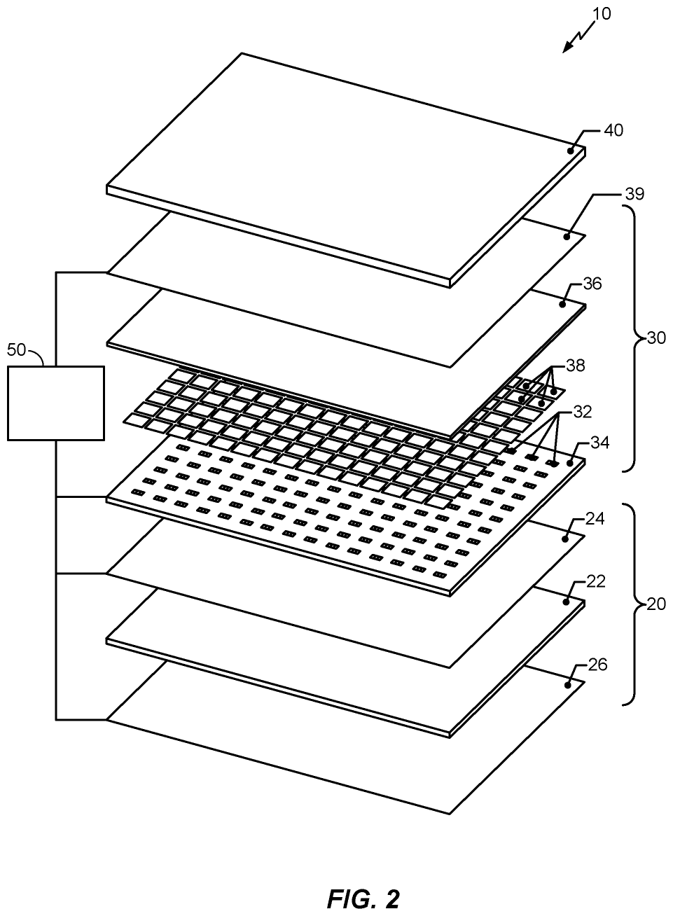

FIG. 2 is an exploded view of the exemplary ultrasonic sensor system 10, including an ultrasonic transmitter 20 and an ultrasonic receiver 30 under a platen 40, according to aspects of the disclosure. The ultrasonic transmitter 20 may be a plane wave generator including a substantially planar piezoelectric transmitter layer 22. Ultrasonic waves may be generated by applying a voltage to the piezoelectric layer to expand or contract the layer, depending upon the signal applied, thereby generating a plane wave. The voltage may be applied to the piezoelectric transmitter layer 22 via a first transmitter electrode 24 and a second transmitter electrode 26. In this fashion, an ultrasonic wave may be made by changing the thickness of the layer. This ultrasonic wave travels toward a finger (or other object to be detected), passing through the platen 40. A portion of the wave not absorbed by the object to be detected may be reflected so as to pass back through the platen 40 and be received by the ultrasonic receiver 30. The first and second transmitter electrodes 24 and 26 may be metallized electrodes, for example, metal layers that coat opposing sides of the piezoelectric transmitter layer 22.

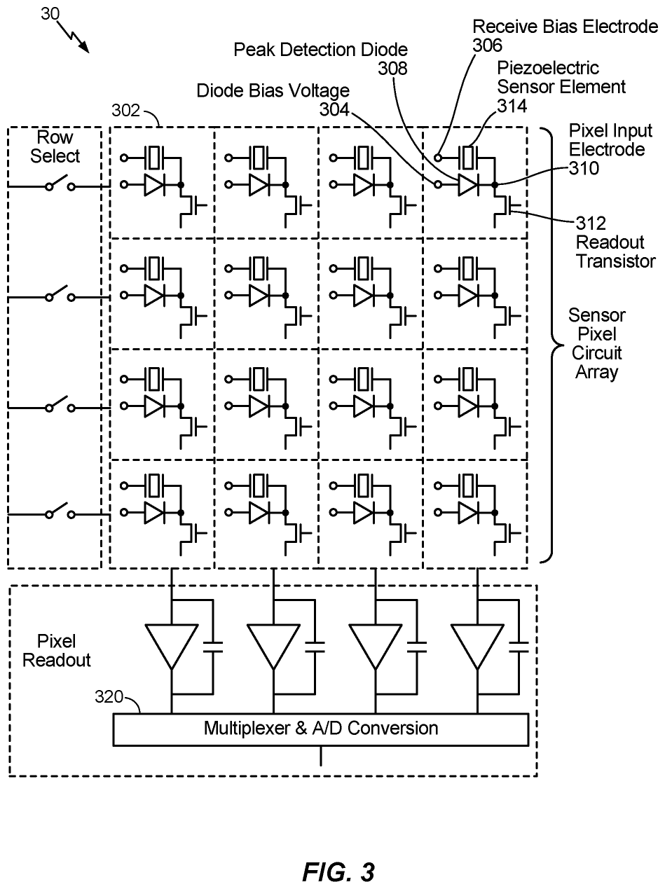

The ultrasonic receiver 30 may include an array of pixel circuits 32 disposed on a substrate 34, which also may be referred to as a backplane, and a piezoelectric receiver layer 36. In some implementations, each pixel circuit 32 may include one or more TFT elements and, in some implementations, one or more additional circuit elements such as diodes, capacitors, and the like. Each pixel circuit 32 may be configured to convert an electric charge generated in the piezoelectric receiver layer 36 proximate to the pixel circuit into an electrical signal. Each pixel circuit 32 may include a pixel input electrode 38 that electrically couples the piezoelectric receiver layer 36 to the pixel circuit 32. In the illustrated implementation, a receiver bias electrode 39 is disposed on a side of the piezoelectric receiver layer 36 proximal to platen 40. The receiver bias electrode 39 may be a metallized electrode and may be grounded or biased to control which signals are passed to the TFT array. Ultrasonic energy that is reflected from the exposed (top) surface of the platen 40 is converted into localized electrical charges by the piezoelectric receiver layer 36. These localized charges are collected by the pixel input electrodes 38 and are passed on to the underlying pixel circuits 32. The charges are amplified by the pixel circuits 32 and then provided to the control electronics, which processes the amplified signals. A simplified schematic of an example pixel circuit 32 is shown in FIG. 3, however one of ordinary skill in the art will appreciate that many variations of and modifications to the example pixel circuit 32 shown in the simplified schematic may be contemplated.

Control electronics 50 may be electrically connected with the first transmitter electrode 24 and the second transmitter electrode 26, as well as with the receiver bias electrode 39 and the pixel circuits 32 on the substrate 34. The control electronics 50 may operate as discussed above with respect to FIGS. 1A and 1B.

The platen 40 may be any appropriate material that can be acoustically coupled to the ultrasonic receiver 30, with examples including plastic, ceramic, and glass. In some implementations, the platen 40 can be a cover plate, such as a cover glass or a lens glass for a display. Detection and imaging can be performed through relatively thick platens if desired, for example, 3 mm and above.

Examples of piezoelectric materials that may be employed include piezoelectric polymers having appropriate acoustic properties, such as an acoustic impedance between about 2.5 MRayls and 5 MRayls. Specific examples of piezoelectric materials that may be employed include ferroelectric polymers such as polyvinylidene fluoride (PVDF) and polyvinylidene fluoride-trifluoroethylene (PVDF-TrFE) copolymers. Examples of PVDF copolymers include 60:40 (molar percent) PVDF-TrFE, 70:30 PVDF-TrFE, 80:20 PVDF-TrFE, and 90:10 PVDR-TrFE. Other examples of piezoelectric materials that may be employed include polyvinylidene chloride (PVDC) homopolymers and copolymers, polytetrafluoroethylene (PTFE) homopolymers and copolymers, and diisopropylammonium bromide (DIPAB).

The thickness of each of the piezoelectric transmitter layer 22 and the piezoelectric receiver layer 36 may be selected so as to be suitable for generating and receiving ultrasonic waves. In one example, a PVDF piezoelectric transmitter layer 22 may be approximately 28 μm thick and a PVDF-TrFE receiver layer 36 is approximately 12 μm thick. Example frequencies of the ultrasonic waves are in the range of 5 MHz to 30 MHz, with wavelengths on the order of a quarter of a millimeter or less.

FIGS. 1A to 2 show example arrangements of ultrasonic transmitters and receivers in an ultrasonic sensor system 10, but other arrangements are possible. For example, in some implementations, the ultrasonic transmitter 20 may be above the ultrasonic receiver 30, i.e., closer to the object of detection. In some implementations, the ultrasonic sensor system 10 may include an acoustic delay layer. For example, an acoustic delay layer can be incorporated into the ultrasonic sensor system 10 between the ultrasonic transmitter 20 and the ultrasonic receiver 30. An acoustic delay layer can be employed to adjust the ultrasonic pulse timing, and at the same time electrically insulate the ultrasonic receiver 30 from the ultrasonic transmitter 20. The delay layer may have a substantially uniform thickness, with the material used for the delay layer and/or the thickness of the delay layer selected to provide a desired delay in the time for reflected ultrasonic energy to reach the ultrasonic receiver 30. In doing so, the range of time during which an energy pulse that carries information about the object by virtue of having been reflected by the object may be made to arrive at the ultrasonic receiver 30 during a time range when it is unlikely that energy reflected from other parts of the ultrasonic sensor system 10 is arriving at the ultrasonic receiver 30. In some implementations, the TFT substrate 34 and/or the platen 40 may serve as an acoustic delay layer.

FIG. 3 illustrates an exemplary 4-by-4 pixel array of pixel circuits 302 for an ultrasonic receiver (e.g., ultrasonic receiver 30), according to aspects of the disclosure. Each pixel circuit 302 is associated with a local region of piezoelectric sensor material, a diode bias voltage 304, a receive bias electrode 306, a peak detection diode 308, a pixel input electrode 310, and a readout transistor 312. Each pixel circuit 302 may also be associated with other elements that are not shown for the sake of simplicity. Many or all of these elements may be formed on or in the backplane to form the pixel circuit 302. In practice, the local region of piezoelectric sensor material of each pixel circuit 302 may transduce received ultrasonic energy into electrical charges. The peak detection diode 308 may register the maximum amount of charge detected by the local region of piezoelectric sensor material (via a piezoelectric sensor element 314). Each row of the pixel array may then be scanned (e.g., through a row select mechanism, a gate driver, or a shift register), and the readout transistor 312 for each column may be triggered to allow the magnitude of the peak charge for each pixel circuit 302 to be read by additional circuitry (e.g., a multiplexer and an A/D converter 320). The pixel circuit 302 may include one or more TFTs to allow gating, addressing, and resetting of the pixel circuit 302.

Each pixel circuit 302 may provide information about a small portion of the object detected by the ultrasonic sensor system 10. While, for convenience of illustration, the example shown in FIG. 3 is of a relatively coarse resolution, ultrasonic sensor systems having a resolution on the order of 500 pixels-per-inch or higher may be configured with a layered structure substantially similar to that shown in FIG. 2. The detection area of the ultrasonic sensor system 10 may be selected depending on the intended object of detection. For example, the detection area may range from 5-by-5 mm for a single finger to 3-by-3 inches for four fingers. Smaller and larger areas may be used as appropriate for the object.

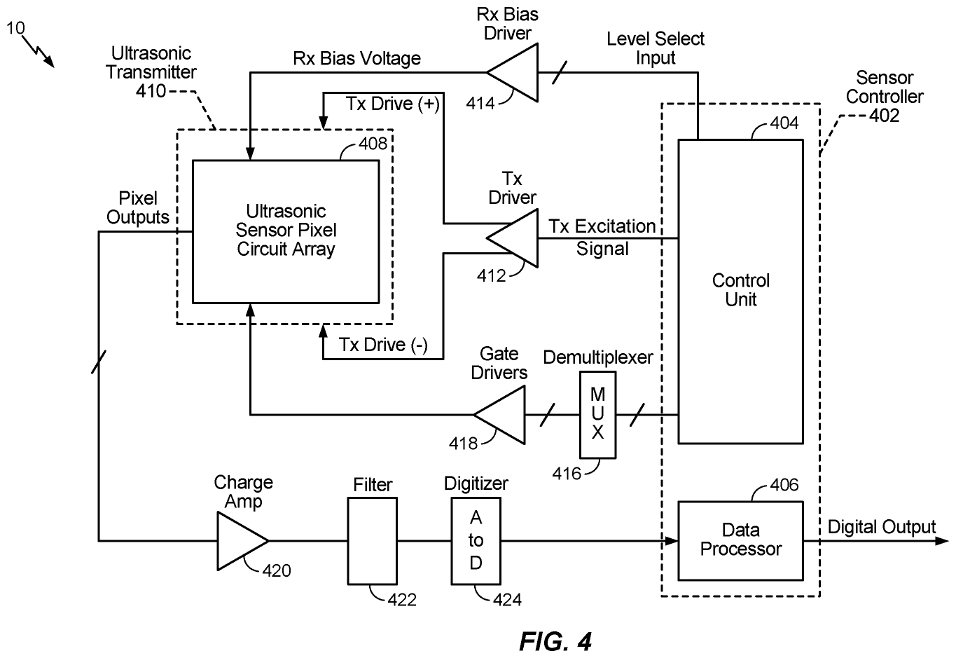

FIG. 4 illustrates a high-level block diagram of the exemplary ultrasonic sensor system 10, according to aspects of the disclosure. Many of the elements shown may form part of control electronics 50. A sensor controller 402 may include a control unit 404 that is configured to control various aspects of the ultrasonic sensor system 10, such as ultrasonic transmitter timing and excitation waveforms, bias voltages for the ultrasonic receiver and pixel circuitry, pixel addressing, signal filtering and conversion, readout frame rates, and so forth. The sensor controller 402 may also include a data processor 406 that receives data from the ultrasonic sensor pixel circuit array 408. The data processor 406 may translate the digitized data into image data of a fingerprint or format the data for further processing. In some aspects, the digitized data is translated into image data of one or more objects other than a finger or for purposes other than obtaining a fingerprint. For example, an image of a palm, an ear, a face, an inanimate object, or one or more other objects may be obtained and/or processed.

For example, the control unit 404 may send a transmitter (Tx) excitation signal to a Tx driver 412 at regular intervals to cause the Tx driver 412 to excite the ultrasonic transmitter 410 and produce planar ultrasonic waves. The control unit 404 may send level select input signals through a receiver (Rx) bias driver 414 to bias the receiver bias electrode and allow gating of acoustic signal detection by the ultrasonic sensor pixel circuit array 408. A demultiplexer 416 may be used to turn on and off gate drivers 418 that cause a particular row or column of the ultrasonic sensor pixel circuit array 408 to provide output signals. Output signals from the pixels may be sent through a charge amplifier 420, a filter 422 (such as a resistor-capacitor (RC) filter or an anti-aliasing filter), and a digitizer 424 to the data processor 406. Note that portions of the ultrasonic sensor system 10 may be included on the TFT backplane and other portions may be included in or on an associated integrated circuit.

TFTs generally suffer from high flicker noise that limits the performance of the pixels (e.g., pixel circuits 302). To mitigate the flicker noise, a large integration time can be used to decrease the signal-to-noise ratio (SNR). Integration is when the voltage across a pixel is set to a known potential, and the pixel is then left to collect ultrasonic energy for a known period of time before the voltage is read out. However, while increasing accuracy, this can impact the frame readout time (i.e., the time it takes to read the data from each pixel circuit of the pixel array).

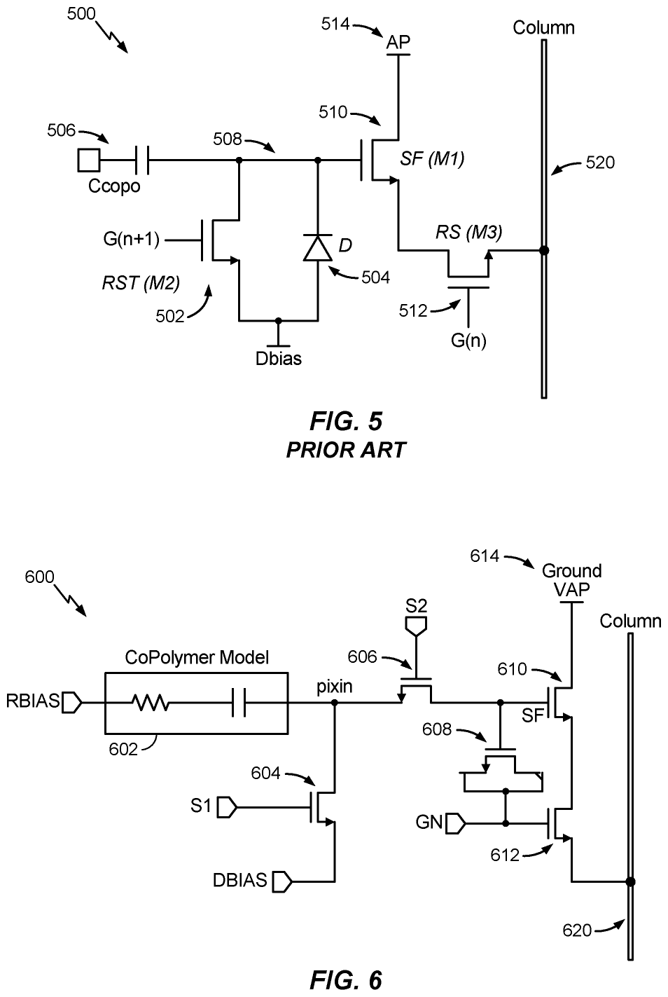

FIG. 5 is a schematic of an exemplary conventional pixel circuit 500 that employs a common-mode to peak voltage sampling architecture. The pixel circuit 500 includes a reset device 502 (the transistor labeled “RST(M2)”), coupled to an input signal labeled “G(n+1),” and a diode 504 (labeled “D”) that together sample the ultrasonic signal received from a copolymer capacitor 506 (labeled “Ccopo”). The copolymer capacitor 506 may be located between the piezoelectric transmitter and receiver layers (e.g., piezoelectric transmitter layer 22 and piezoelectric receiver layer 36, where the ultrasonic transmitter 20 is located between the platen 40 and the ultrasonic receiver 30) and receives the ultrasonic signal reflected off of the object being detected (e.g., a user's finger). The sampled ultrasonic signal is then stored at the gate 508 between the reset device 502 and the diode 504 until it can be read out.

The pixel circuit 500 further includes an output device 510 (the source follower transistor labeled “SF(M1)”) that drives the received ultrasonic signal out to the column 520. More specifically, when power is applied to the output device 510 by the array power (AP) 514, the output device 510 reads the ultrasonic signal that was captured and stored at the gate 508. At the same time, or shortly after, a transistor switch 512 (driven by a signal labeled “G(n)”) selects the pixel circuit 500, allowing the output device 510 to output the captured ultrasonic signal through to the column 520. The flicker noise of the output device 510 is the noise source that dominates the pixel circuit 500.

The present disclosure proposes a peak-to-peak sampling architecture (as opposed to the conventional common-mode to peak sampling architecture illustrated in FIG. 5) for the pixel with a drive scheme that provides a passive gain to the sampled signal as well as sampled noise. This passive gain mitigates (i.e., makes the pixel less sensitive to) the effect of higher flicker noise, thereby providing a higher SNR. In addition, because the effect of higher flicker noise is mitigated, it eases filtering requirements during sensing, thereby reducing sensing delay and increasing the frame rate. The present disclosure also proposes a way to mitigate any pixel sampled voltage leakage due to the higher TFT leakage, without affecting the pixel SNR. Leakage occurs when a signal being held in the pixel until it can be read (since the pixel array is read out line by line) dissipates, or leaks out.

FIG. 6 is a schematic diagram of an exemplary pixel circuit 600 that employs a peak-to-peak voltage sampling architecture, according to aspects of the disclosure. The pixel circuit 600 includes two transistor switches 604 and 606 that receive digital inputs signals “S1” and “S2,” respectively, in order to sample the ultrasonic signal received from a copolymer model 602. The copolymer model 602, like the copolymer capacitor 506 in FIG. 5, may be located between the piezoelectric transmitter and receiver layers and receives the ultrasonic signal (referred to as R_{BIAS}) reflected off of the object being detected (e.g., a user's finger). The sampled ultrasonic signal is then stored between the switches 604 and 606 until it can be read out.

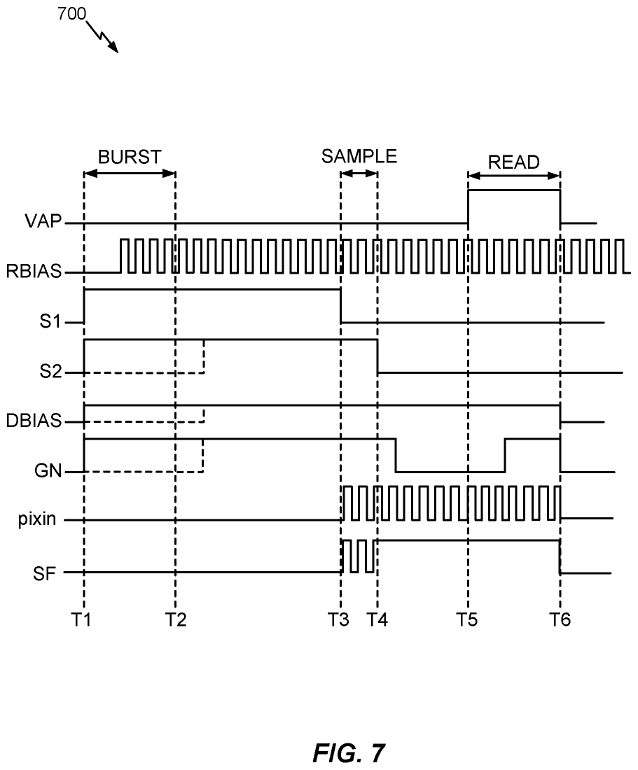

An output device 610, which is a source follower (SF) transistor like the output device 510, drives the received ultrasonic signal out to the column 620. Before a read operation, the output device 610 is connected to ground 614. However, when power is applied to the output device 610 by the voltage array power (VAP) 614, the output device 610 reads the ultrasonic signal that was captured and stored at the gate net of the output device 610. At the same time, or shortly after, a transistor switch 612, like the switch 512, selects the pixel circuit 600 based on activation of the signal “GN,” allowing the output device 610 to output the captured ultrasonic signal through to the column 620. As described below with reference to FIG. 7, the timing between switches 604 and 606 enables the circuit to sample the peak-to-peak voltage of the sampled ultrasonic signal at the gate of the output device 610. In addition, as described further below, the output device 610 provides a passive gain for the sampled ultrasonic signal as it is read out.

The pixel circuit 600 further includes a leakage mitigation device 608, which is an additional transistor between the gate terminal of the output device 610 and the node of the switch 612. This provides additional capacitance to hold the sampled signal while the pixel circuit 600 is not being read. The GN net is driven such that no channel (i.e., the electrical pathway between the drain and source regions of the transistor) exists in the leakage mitigation device 608 when the pixel circuit 600 is being read. Thus, the OFF additional capacitance due to the leakage mitigation device 608 is significantly smaller while the ultrasonic signal is being read. As such, the additional capacitance does not affect the SNR performance of the pixel circuit 600. For example, there is no gain degradation because there is no additional capacitance during a read operation.

Note that in the prior art pixel circuit 500, D_{BIAS} is a high-speed analog control that performs the sampling edge function, which requires a high-powered amplifier to drive and switch the high-capacitance network very quickly. In contrast, in the pixel circuit 600, that function has been replaced by the digital S1 and S2 signals, and D_{BIAS} is a fixed net that does not need to change, it is simply a direct current (DC) voltage.

FIG. 7 is a diagram 700 of an exemplary signal flow through the pixel circuit 600 of FIG. 6, according to aspects of the disclosure. In the diagram 700, time is represented on the horizontal axis and increases from left to right, and voltage is represented on the vertical axis and increases from bottom to top.

From time T1 to T2, a burst of ultrasonic signals are emitted by a piezoelectric transmitter layer (e.g., piezoelectric transmitter layer 22). The signal representing the reflections of the transmitted ultrasonic signals detected by the copolymer model 602 is referred to as R_{BIAS}. During this time, the voltages of the signals S1 (coupled to switch 604 in FIG. 6) and S2 (coupled to switch 606 in FIG. 6) are high, meaning that switches 604 and 606, respectively, are closed. More specifically, the gate voltages of these switches are held at supply level, thereby keeping the switches closed.

From time T3 to T4, the pixel circuit 600 samples the reflections of the ultrasonic signals that were transmitted from time T1 to T2. Specifically, at time T3, the voltage of S1 drops, opening switch 604. At this point, the voltage of pixin (the input signal to the pixel circuit 600 from the copolymer model 602, see FIG. 6), which was at low voltage because switch 604 was closed, begins tracking the input signal for as long as switch 604 is open. Likewise, the voltage at the gate of the output device 610 (labeled “SF” in FIG. 7), which was at D_{BIAS} because switch 604 was closed, also begins tracking the input signal.

At time T4, the voltage of S2 drops, opening switch 606. At this point, the voltage at the gate of the output device 610 is held at whatever level it was at when switch 606 was opened. By tuning the time interval between T3 and T4 and their absolute phase, the circuit is configured to capture the peak to peak input signal.

From time T5 to T6, the pixel circuit 600 is read out. During this time, the voltages of VAP 614 (previously ground) and GN (the signal driving switch 612) go high, permitting the voltage of the output device 610 to be read out to the column 620. Note that the time from T4 to T5 is the hold time of the pixel circuit 600, and varies based on the number of pixels in the pixel array. A larger pixel array may necessitate a longer hold time since pixels are read serially.

Referring now to the passive gain factor, the drain and source sides of the output device 610 are held at ground (i.e., by ground 614) until time T5 (the beginning of a read operation), meaning the net (intersection) between the output device 610 and the leakage mitigation device 608 sees the full capacitance of the output device 610 until time T5. However, during a read operation, the output device 610 is pushed into saturation region, meaning that only a portion of the capacitance of the output device 610 is seen at the net. Because the capacitance at the net is reduced when the stored signal value is being read, the voltage at the net must go up due to the conservation of charge. Note that changing the capacitance at a net or a device is referred to as modulating the capacitance.

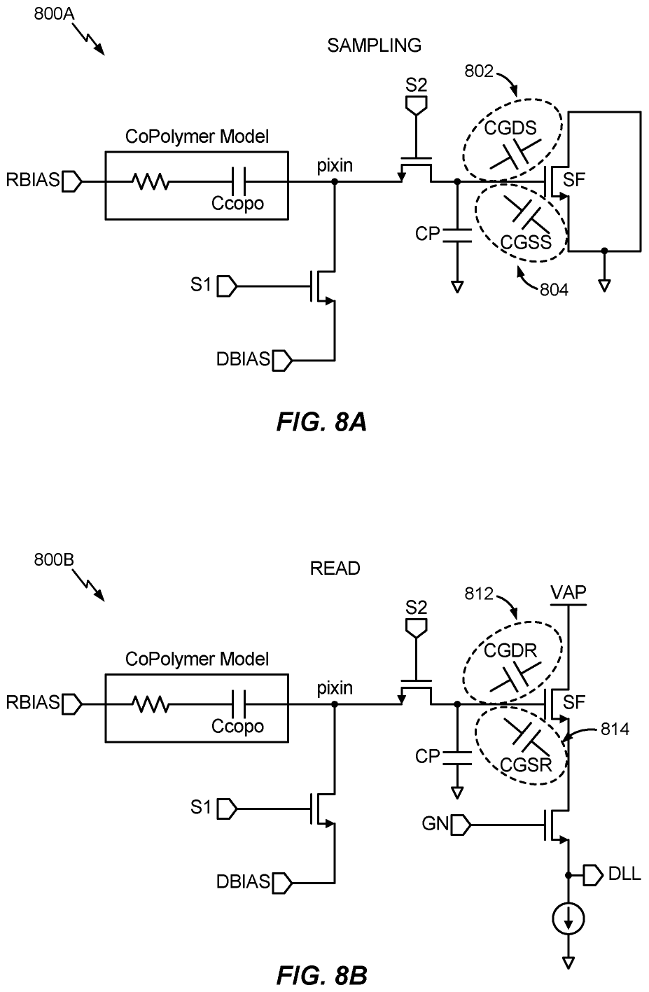

More specifically, charge (Q) is equal to capacitance (C) times voltage (V). If, before a read, the capacitance and voltage at the net are C₁ and V₁, respectively, and then, during a read, change to C₂ and V₂, respectively, then V₂ is equal to C₁ times V₁ divided by C₂. If C₂ is less than C₁, as during a read operation, then V₂ will be higher than V₁ during the read operation. Thus, when the input signal is being sampled, the capacitance at the net between the output device 610 and the leakage mitigation device 608 is large, but when the pixel circuit 600 is being read, the capacitance at the net is low. This voltage increase during a read passively increases the gain of the sampled signal. This is illustrated by FIGS. 8A and 8B.

FIGS. 8A and 8B illustrate the change in capacitance in the pixel circuit 600 during sampling and reading, according to aspects of the disclosure. Specifically, FIG. 8A is a schematic diagram 800A showing the signaling appearance of the pixel circuit 600 during sampling (e.g., between times T3 and T4 in FIG. 7), and FIG. 8B is a schematic diagram 800B showing the signaling appearance of the pixel circuit 600 during a read (e.g., between times T5 and T6 in FIG. 7). As shown in FIG. 8A, the gate-to-drain capacitance during sampling (C_{GDS}) 802 and the gate-to-source capacitance during sampling (C_{GSS}) 804 are at their highest levels. In contrast, during a read, as shown in FIG. 8B, the gate-to-drain capacitance during read (C_{GDR}) 812 and the gate-to-source capacitance during read (C_{GSR}) 814 drop, meaning voltage increases due to conservation of charge.

This is represented in the following equations:

$$Gainsmp = \frac{C c o p o}{C c o p o + C p + C g ss + Cgds}$$

$$Cgss = C g s 0 + \frac{C g}{2}$$

$$Cgds = Cgd 0 + \frac{C g}{2}$$

$$Gainread = Gainsmp * Kick$$

$$Kick = \frac{C p + C g s s + C g d s}{C p + C g d r + α * C g s r}$$

$$C g s r = C g s 0 + \frac{2 * C g}{3}$$

$$α ≪ 1$$

$$Cgdr = Cgd 0$$

where Gainsmp is the sampling gain, Gainread is the read gain, Ccopo is the copolymer capacitance, Cp is the parasitic capacitance at the gate of the output device 610, Cgss is the gain-source capacitance of the output device 610 during sampling, Cgds is the gate-drain capacitance of the output device 610 during sampling, Cgsr is the gate-source capacitance of the output device 610 during read, Cgdr is the gate-drain capacitance of the output device 610 during read, Cgso is the gate-source overlap capacitance of the output device 610, and Cg is the gate capacitance of the output device 610.

Note that C_{GDS} 802, C_{GSS} 804, C_{GDR} 812, and C_{GSR} 814 are not physical capacitors, but rather, represent the gate-to-drain capacitance during sampling (C_{GDS} 802), the gate-to-source capacitance during sampling (C_{GSS} 804), the gate-to-drain capacitance during read (C_{GDR} 812), and the gate-to-source capacitance during read (C_{GSR} 814).

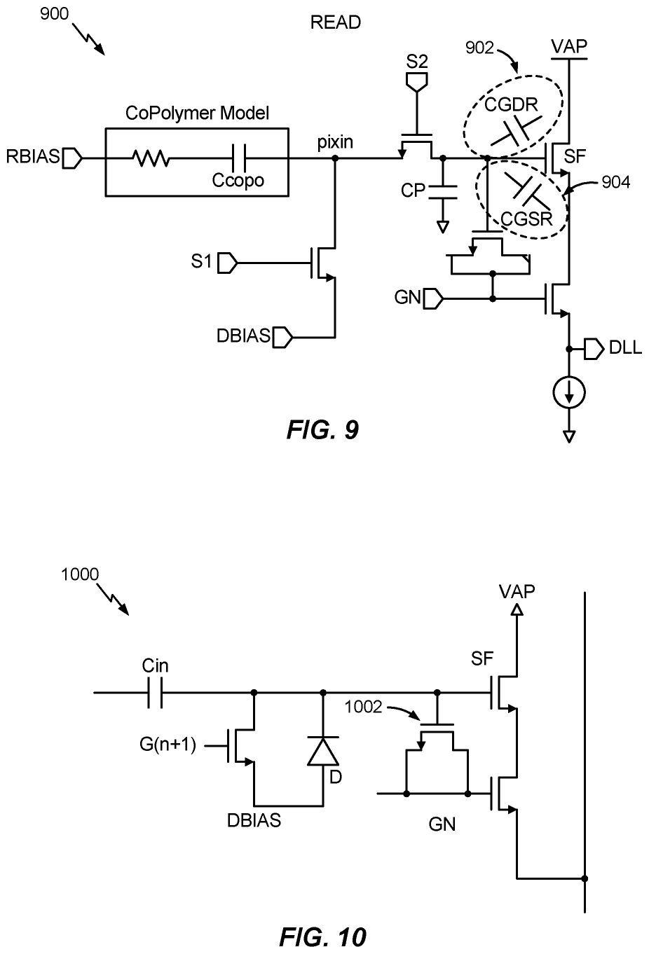

Referring now to leakage mitigation in more detail, as shown in FIG. 7, before a read, the voltage of GN (which drives switch 612) is high, meaning that the capacitance at the net between the switch 612 and the leakage mitigation device 608 is not seen. When GN goes low, as during the hold time between times T4 and T5, the channel through the leakage mitigation device 608 appears, as well as the capacitance of the leakage mitigation device 608. Because the capacitance of the leakage mitigation device 608 increases when the GN goes low, the voltage at the net between the output device 610 and the leakage mitigation device 608 drops. Further, the large capacitance at the net between the output device 610 and the leakage mitigation device 608 due to the capacitance of the leakage mitigation device 608 mitigates the leakage into D_{BIAS} from signals S1 and S2. Then, when the pixel circuit 600 is ready to be read and GN goes high again (as between times T5 and T6), the voltage at the net between the output device 610 and the leakage mitigation device 608 also goes high again (back to its normal value) because the capacitance at the leakage mitigation device 608 disappears. Subsequently, when the output device 610 enters into its saturation region, its voltage increases by another factor, which would be the passive gain factor described above. This is illustrated by FIG. 9.

FIG. 9 illustrates the change in capacitance in the pixel circuit 600 during a read operation, according to aspects of the disclosure. Specifically, FIG. 9 is a schematic diagram 900 showing the signaling appearance of the pixel circuit 600 during a read operation (e.g., between times T5 and T6 in FIG. 7) but before the pixel circuit 600 has been read. The capacitance of the leakage mitigation device 608 (C_{GDR} 902 and C_{GSR} 904) is only active when the voltage of GN is low (i.e., when the pixel circuit 600 is not being read). As such, this capacitance will hold the charge on the sampling node until the pixel circuit 600 is read. However, this capacitance has no affect during sampling and reading since the voltage of GN is equivalent to the supply voltage (VAP). Note that C_{GDR} 902 and C_{GSR} 904 are not physical capacitors, but rather, represent the gate-to-drain capacitance during read (C_{GDR} 902) and the gate-to-source capacitance during read (C_{GSR} 904).

The design of the pixel circuit 600 improves the output SNR of the circuit. For example, if there were no additional gain in the pixel circuit 600, the output of the pixel would be the measured/sampled signal plus the noise of the output device 610. However, due to the passive gain increase discussed above, the output of the pixel circuit 600 is the measured/sampled signal multiplied by a gain factor plus the noise of the output device 610. Thus, because the noise of the output device 610 does not change but the gain of the output signal increases, the SNR of the pixel circuit 600 is improved.

This is represented in the following equations:

$$Noisesampled = Noisesmp$$

$$Noiseread = ( Kick * Noisesmp ) ⊕ ( Noiseflicker )$$

$$FOM = Kick * \frac{G a i n s m p}{( Kick * Noisesmp ) ⊕ ( N o i s e f l i c k e r )}$$

$$FOM = \frac{G a i n s m p}{( N o i s e s m p ) ⊕ ( N o i s e f l icker / Kick )}$$

where Noisesmp is the noise at the sample net (i.e., the gate of the output device 610), Noiseread is the noise at the pixel output during read, Noiseflicker is the flicker noise of the output device 610, FOM is the figure of merit, Kick is computed in the previous set of equations, and Gainsmp is computed in the previous set of equations.

Any flicker noise of the output device 610 can be ignored if there is a sufficient kick. In addition, the size of the output device 610 needs to be optimized to achieve a sufficient SNR, as both gain and noise decrease with size.

The design of the pixel circuit 600 can significantly improve the SNR of the pixel circuit 600. In addition, the frame rate can be as high as three to six times the frame rate of previous generations. Further, the pixel circuit 600 can achieve the same performance as the previous generation with almost three times less tone-burst voltage.

In an aspect, adding a leakage mitigation device to a conventional pixel circuit, such as pixel circuit 500 in FIG. 5, may be beneficial. FIG. 10 is a schematic diagram of an exemplary pixel circuit 1000, according to aspects of the disclosure. The pixel circuit 1000 is similar to the pixel circuit 500, except that a leakage mitigation device 1002 coupled to the signal “GN” has been added between the diode “D” and the output device “SF.” Like the leakage mitigation device 608, the leakage mitigation device 1002 may be a transistor. In addition, the leakage mitigation device 1002 would operate as described above with reference to the leakage mitigation device 608.

In contrast to the leakage mitigation device 608, the leakage mitigation device 1002 would only provide a small gain improvement for the output signal, as it would only influence the capacitance of the output device SF. However, it would provide leakage mitigation, as described above with respect to leakage mitigation device 608, for the sampling devices between the input signal (Cᵢₙ) and the output device SF.

Note that while the transistors described herein have been illustrated as n-channel transistors, they may instead be p-channel transistors. In addition, they are not limited to TFT-type transistors, but rather, may be any type of MOSFET-type transistors, or even other types of transistors, such as bipolar junction transistors (BJTs), junction gate field-effect transistors (JFETs), insulated-gate bipolar transistors (IGBTs), etc.

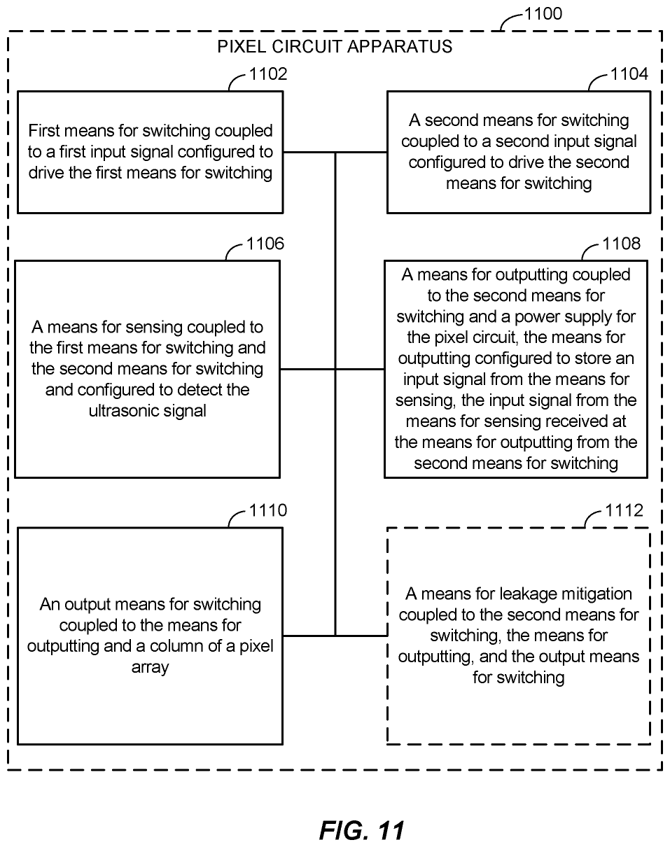

FIG. 11 illustrates an exemplary pixel circuit apparatus 1100 for sensing an ultrasonic signal, according to aspects of the disclosure. In an aspect, the pixel circuit apparatus 1100 includes a first means for switching 1102 coupled to a first input signal configured to drive the first means for switching, a second means for switching 1104 coupled to a second input signal configured to drive the second means for switching, a means for sensing 1106 coupled to the first means for switching and the second means for switching and configured to detect the ultrasonic signal, a means for outputting 1108 coupled to the second means for switching and a power supply for the pixel circuit, wherein the means for outputting is configured to store an input signal from the means for sensing, wherein the input signal from the means for sensing is received at the means for outputting from the second means for switching, an output means for switching 1110 coupled to the means for outputting and a column of a pixel array, wherein the means for outputting is configured to output the input signal to the column of the pixel array based on activation of the output means for switching, and an optional means for leakage mitigation coupled to the second means for switching, the means for outputting, and the output means for switching.

In an aspect, the first means for switching 1102 may correspond to the first switch 604 in FIG. 6 or equivalents thereof, the second means for switching 1104 may correspond to the second switch 606 in FIG. 6 or equivalents thereof, the means for sensing 1106 may correspond to the copolymer capacitor 506 in FIG. 5 or the copolymer model 602 in FIG. 6 or equivalents thereof, the means for outputting 1108 may correspond to the output device 610 in FIG. 6 or equivalents thereof, the output means for switching 1110 may correspond to the switch 612 in FIG. 6 or equivalents thereof, and the means for leakage mitigation 1112 may correspond to the leakage mitigation device 608 in FIG. 6 or equivalents thereof.

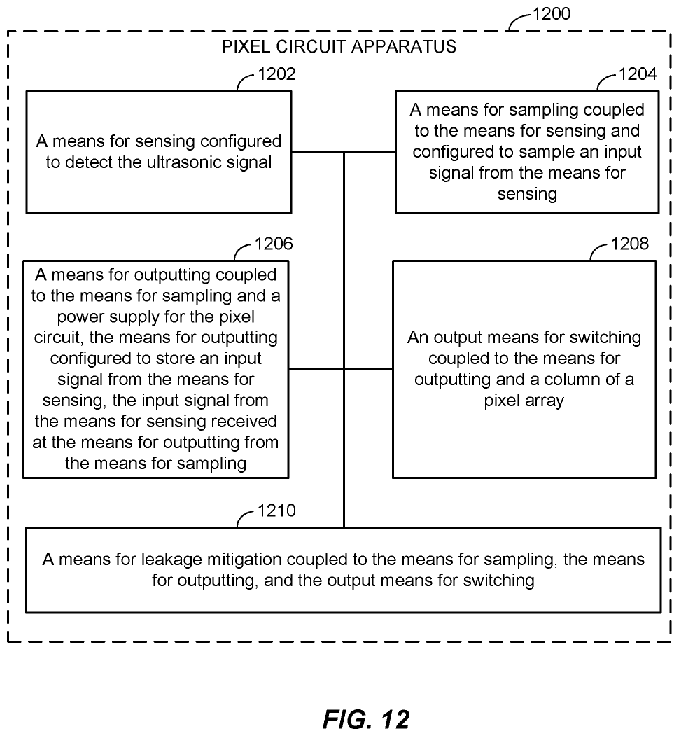

FIG. 12 illustrates an exemplary pixel circuit apparatus 1200 for sensing an ultrasonic signal, according to aspects of the disclosure. In an aspect, the pixel circuit apparatus 1200 includes a means for sensing 1202 configured to detect the ultrasonic signal, a means for sampling 1204 coupled to the means for sensing and configured to sample an input signal from the means for sensing, a means for outputting 1206 coupled to the means for sampling and a power supply for the pixel circuit, wherein the means for outputting is configured to store an input signal from the means for sensing, wherein the input signal from the means for sensing is received at the means for outputting from the means for sampling, an output means for switching 1208 coupled to the means for outputting and a column of a pixel array, and a means for leakage mitigation 1210 coupled to the means for sampling, the means for outputting, and the output means for switching, wherein the means for outputting is configured to output the input signal to the column of the pixel array based on activation of the output means for switching.

In an aspect, the means for sensing 1202 may correspond to the copolymer capacitor 506 in FIG. 5 or the copolymer model 602 in FIG. 6 or equivalents thereof, the means for sampling 1204 may correspond to the reset device 502 and the diode 504 in FIG. 5, the first switch 604 and the second switch 606 in FIG. 6, or equivalents thereof, the means for outputting 1206 may correspond to the output device 510 in FIG. 5, the output device 610 in FIG. 6, or equivalents thereof, the output means for switching 1208 may correspond to the switch 512 in FIG. 5, the switch 612 in FIG. 6, or equivalents thereof, and the means for leakage mitigation 1210 may correspond to the leakage mitigation device 608 in FIG. 6, the leakage mitigation device 1002 in FIG. 10, or equivalents thereof.

The fingerprint scanners and pixel circuits described above may be integrated into any number of different types of electronic devices, such as cell phones (e.g., smartphones), tablet computers, laptop computers, desktop computers, server computers, tracking devices, wearable devices (e.g., smartwatches, glasses, augmented reality (AR)/virtual reality (VR) headsets, etc.), vehicles (e.g., automobile, motorcycle, bicycle, etc.), Internet of Things (IoT) devices, etc.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A pixel circuit for sensing an ultrasonic signal, comprising:
a first switch coupled to a first input signal configured to drive the first switch;
a second switch coupled to a second input signal configured to drive the second switch;
a capacitor coupled to the first switch and the second switch and configured to detect the ultrasonic signal;
an output device coupled to the second switch and a power supply for the pixel circuit, wherein the output device is configured to store an input signal from the capacitor, wherein the input signal from the capacitor is received at the output device from the second switch; and
an output switch coupled to the output device and a column of a pixel array,
wherein the output device is configured to output the input signal to the column of the pixel array based on activation of the output switch.

2. The pixel circuit of claim 1, further comprising:
a leakage mitigation device coupled to the second switch, the output device, and the output switch.

3. The pixel circuit of claim 2, wherein a capacitance of the leakage mitigation device causes the pixel circuit to store the ultrasonic signal while the pixel circuit is not being read.

4. The pixel circuit of claim 2, wherein a switch signal drives the output switch and the leakage mitigation device, and wherein a direct current (DC) drive signal is coupled to the first switch.

5. The pixel circuit of claim 4, wherein, based on a voltage of the switch signal being at a low voltage level, a capacitance of the leakage mitigation device is not present at a coupling of the output device and the leakage mitigation device, and a voltage at the coupling of the output device and the leakage mitigation device is at the low voltage level.

6. The pixel circuit of claim 5, wherein the capacitance of the leakage mitigation device mitigates leakage into the DC drive signal from the first signal and the second signal.

7. The pixel circuit of claim 4, wherein, based on a voltage of the switch signal being at a high voltage level, a voltage at a coupling of the output device and the leakage mitigation device is at the high voltage level.

8. The pixel circuit of claim 2, wherein, based on a drain terminal and a source terminal of the output device being held at ground until a read operation of the pixel circuit begins, a full capacitance of the output device is present at a coupling between the output device and the leakage mitigation device.

9. The pixel circuit of claim 2, wherein, based on the output device being pushed into a saturation region during a read operation of the pixel circuit, less than a full capacitance of the output device is present at a coupling between the output device and the leakage mitigation device, and a voltage at the coupling is increased.

10. The pixel circuit of claim 2, wherein the leakage mitigation device comprises a transistor.

11. The pixel circuit of claim 10, wherein a ground terminal of the leakage mitigation device is coupled to the second switch and the output device, and a source terminal and a drain terminal of the leakage mitigation device are coupled to the output switch.

12. The pixel circuit of claim 1, wherein:
at a beginning of a sampling period of the ultrasonic signal, a voltage of the first signal drops from a high voltage level to a low voltage level, and
at an end of the sampling period, a voltage of the second signal drops from the high voltage level to the low voltage level.

13. The pixel circuit of claim 12, wherein a voltage at the output device tracks a voltage of the input signal from the capacitor during the sampling period, and wherein, at the end of the sampling period, the voltage at the output device is held at the voltage of the input signal.

14. The pixel circuit of claim 1, wherein:
the first switch comprises a first switch transistor,
the second switch comprises a second switch transistor,
the output device comprises a source follower transistor, and
the output switch comprises an output switch transistor.

15. The pixel circuit of claim 1, wherein the pixel circuit is one of a plurality of pixel circuits of the pixel array.

16. The pixel circuit of claim 15, wherein the pixel array is a component of a fingerprint scanner.

17. A pixel circuit for sensing an ultrasonic signal, comprising:
a capacitor configured to detect the ultrasonic signal;
a sampling device coupled to the capacitor and configured to sample an input signal from the capacitor;
an output device coupled to the sampling device and a power supply for the pixel circuit, wherein the output device is configured to store an input signal from the capacitor, wherein the input signal from the capacitor is received at the output device from the sampling device;
an output switch coupled to the output device and a column of a pixel array; and
a leakage mitigation device coupled to the sampling device, the output device, and the output switch,
wherein the output device is configured to output the input signal to the column of the pixel array based on activation of the output switch.

18. The pixel circuit of claim 17, wherein a capacitance of the leakage mitigation device causes the pixel circuit to store the ultrasonic signal while the pixel circuit is not being read.

19. The pixel circuit of claim 17, wherein a switch signal drives the output switch and the leakage mitigation device, and wherein a direct current (DC) signal is coupled to the first switch.

20. The pixel circuit of claim 19, wherein, based on a voltage of the switch signal being at a low voltage level, a capacitance of the leakage mitigation device is not present at a coupling of the output device and the leakage mitigation device, and a voltage at the coupling of the output device and the leakage mitigation device is at the low voltage level.

21. The pixel circuit of claim 20, wherein the capacitance of the leakage mitigation device mitigates leakage into the DC drive signal from the first signal and the second signal.

22. The pixel circuit of claim 19, wherein, based on a voltage of the switch signal being at a high voltage level, a voltage at a coupling of the output device and the leakage mitigation device is at the high voltage level.

23. The pixel circuit of claim 17, wherein, based on a drain terminal and a source terminal of the output device being held at ground until a read operation of the pixel circuit begins, a full capacitance of the output device is present at a coupling between the output device and the leakage mitigation device.

24. The pixel circuit of claim 17, wherein, based on the output device being pushed into a saturation region during a read operation of the pixel circuit, less than a full capacitance of the output device is present at a coupling between the output device and the leakage mitigation device, and a voltage at the coupling is increased.

25. The pixel circuit of claim 17, wherein the leakage mitigation device comprises a transistor.

26. The pixel circuit of claim 17, wherein the sampling device comprises:
a first switch coupled to a first input signal configured to drive the first switch; and
a second switch coupled to a second input signal configured to drive the second switch.

27. The pixel circuit of claim 17, wherein the sampling device comprises:
a reset device;
a diode, wherein a gate between the reset device and the diode is coupled to the capacitor and the output device; and
a direct current (DC) drive signal that drives the reset device and the diode.

28. The pixel circuit of claim 27, wherein the reset device comprises a transistor.

29. A pixel circuit for sensing an ultrasonic signal, comprising:
a first means for switching coupled to a first input signal configured to drive the first means for switching;
a second means for switching coupled to a second input signal configured to drive the second means for switching;
a means for sensing coupled to the first means for switching and the second means for switching and configured to detect the ultrasonic signal;
a means for outputting coupled to the second means for switching and a power supply for the pixel circuit, wherein the means for outputting is configured to store an input signal from the means for sensing, wherein the input signal from the means for sensing is received at the means for outputting from the second means for switching; and
an output means for switching coupled to the means for outputting and a column of a pixel array,
wherein the means for outputting is configured to output the input signal to the column of the pixel array based on activation of the output means for switching.

30. A pixel circuit for sensing an ultrasonic signal, comprising:
a means for sensing configured to detect the ultrasonic signal;
a means for sampling coupled to the means for sensing and configured to sample an input signal from the means for sensing;
an means for outputting coupled to the means for sampling and a power supply for the pixel circuit, wherein the means for outputting is configured to store an input signal from the means for sensing, wherein the input signal from the means for sensing is received at the means for outputting from the means for sampling;
an output means for switching coupled to the means for outputting and a column of a pixel array; and
a means for leakage mitigation coupled to the means for sampling, the means for outputting, and the output means for switching,
wherein the means for outputting is configured to output the input signal to the column of the pixel array based on activation of the output means for switching.
